(19) United States
(12) Patent Application Publication
(10) Pub. No.: US 2009/0164268 A1
(43) Pub. Date: Jun. 25, 2009

(54) SYSTEM AND METHOD FOR ADVERTISER RESPONSE ASSESSMENT

(76) Inventors: Christopher L. Hogan, San Francisco, CA (US); Kerem Tomak, Mountain View, CA (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(21) Appl. No.: 11/963,107

(22) Filed: Dec. 21, 2007

(51) Int. Cl. G06Q 10/00

(52) U.S. Cl. 705/7

(57) ABSTRACT

Embodiments of the present invention provide systems, methods and computer program products for assessing advertiser response based upon change in click traffic and value. One embodiment of a method for assessing advertiser response includes determining one or more keyword markets impacted by a traffic quality action, setting a baseline cost per acquisition for the one or more keyword markets impacted by the traffic quality action, determining one or more advertising metrics for the one or more keyword markets impacted by the traffic quality action having a certain network market value, fitting the one or more advertising metrics into a probabilistic model and determining the probability of reaction of the one or more keyword markets to changes in the one or more advertising metrics. The present invention provides systematic model to assess advertiser response that addresses all of the limitations of today's advertiser response assessment.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention disclosed herein relates generally to assessing advertiser response. More specifically, the present invention provides systems, methods and computer program products for assessing advertiser response on the basis of changes in click traffic and value.

### BACKGROUND OF THE INVENTION

Quantifying advertiser response to changes in traffic flow and quality from a given a content provider is an important factor in understanding the return on investment in improving the overall market quality by that content provider and determining the value of the traffic that given content provider generates. Traditionally, the value of traffic that a content provider generates is determinative upon the conversion rate of advertisements corresponding to a keyword market. It is well known in the art that a conversion is an advertiser-defined action that is performed by a user, such as on-line product purchase, on-line newsletter sign-up, etc. Conversion rate measures the number of successful actions relative to the number of leads an advertiser receives. Therefore, the conversion rate can be thought of as a measure of the value of a search marketing click.

In a competitive market, it is assumed that an advertiser changes his or her monetary bid in a keyword market relative to the click value, which may be measured by the conversion rate. Contrary to this assumption, however, case studies suggest that advertisers do not necessarily change monetary bids in a keyword market solely on the basis of conversation rates. Instead, advertisers quantify click values across a number of other factors, such as an available budget for a given advertiser, number of clicks generated, e.g., targeting click volume, and maintenance of rank to compete with competitors. Therefore, advertiser response measurement serves as an important tool for content providers to quantify and predict the monetary value of keyword markets (“ROI” or Return on Investment). Current techniques for measuring advertiser response, however, are based solely on ad hoc estimation procedures.

Therefore, there exists a need for systems, methods and computer program products that provide for the systematic and consistent assessment of advertiser response based upon changes in click traffic and value.

### SUMMARY OF THE INVENTION

Generally, the present invention provides for systems, methods and computer program products for assessing advertiser response based upon change in click traffic and value. The present invention is directed toward a method for assessing advertiser response and includes determining one or more keyword markets impacted by a traffic quality action, setting a baseline cost per acquisition (“CPA”) for the one or more keyword markets impacted by the traffic quality action, determining one or more advertising metrics for the one or more keyword markets impacted by the traffic quality action having a certain network market value, fitting the one or more advertising metrics into a probabilistic model and determining the probability of reaction of the one or more keyword markets to changes in the one or more advertising metrics.

The present invention also provides for a system for assessing advertiser response which comprises a data extrapolation module operative to extrapolate data corresponding to one or more keyword markets and a data processing module. The data processing module is operative to determine one or more keyword markets impacted by a traffic quality action, setting a baseline CPA for the one or more keyword markets impacted by the traffic quality action, determine one or more advertising metrics for the one or more keyword markets impacted by the traffic quality action having a certain network market value, fit the one or more advertising metrics into a probabilistic model and determine the probability of reaction of the one or more keyword markets to changes in the one or more advertising metrics. The present invention provides systems, methods and computer program products to assess advertiser response that addresses the limitations of current advertiser response assessment techniques and has the ability to easily integrate with existing systems.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of a system for assessing advertiser response to change in click traffic and value according to one embodiment of the present invention;

FIG. 2 illustrates a flow diagram presenting a method for assessing advertiser response to change in click traffic and value according to one embodiment of the present invention;

FIG. 3 illustrates a flow diagram presenting a method for selecting a keyword market impacted by a traffic quality action to assess advertiser response according to one embodiment of the present invention;

FIG. 4 illustrates a flow diagram presenting a method for assigning a network market value to a keyword market impacted by a traffic quality action to assess advertiser response according to one embodiment of the present invention;

FIG. 5 illustrates a flow diagram presenting a method for assigning a network market value to a keyword market impacted by a traffic quality action to assess advertiser response according to another embodiment of the present invention;

FIG. 6 illustrates a flow diagram presenting a method for assigning a network market value to a keyword market impacted by a traffic quality action to assess advertiser response according to another embodiment of the present invention; and

FIG. 7 illustrates a flow diagram presenting a method for assigning a network market value to a keyword market impacted by a traffic quality action to assess advertiser response according to another embodiment of the present invention.

### DETAILED DESCRIPTION OF THE INVENTION

In the following description of the embodiments of the invention, reference is made to the accompanying drawings that form a part hereof, and in which is shown by way of illustration, exemplary embodiments in which the invention may be practiced. It is to be understood that other embodiments may be utilized and structural changes may be made without departing from the scope of the present invention.

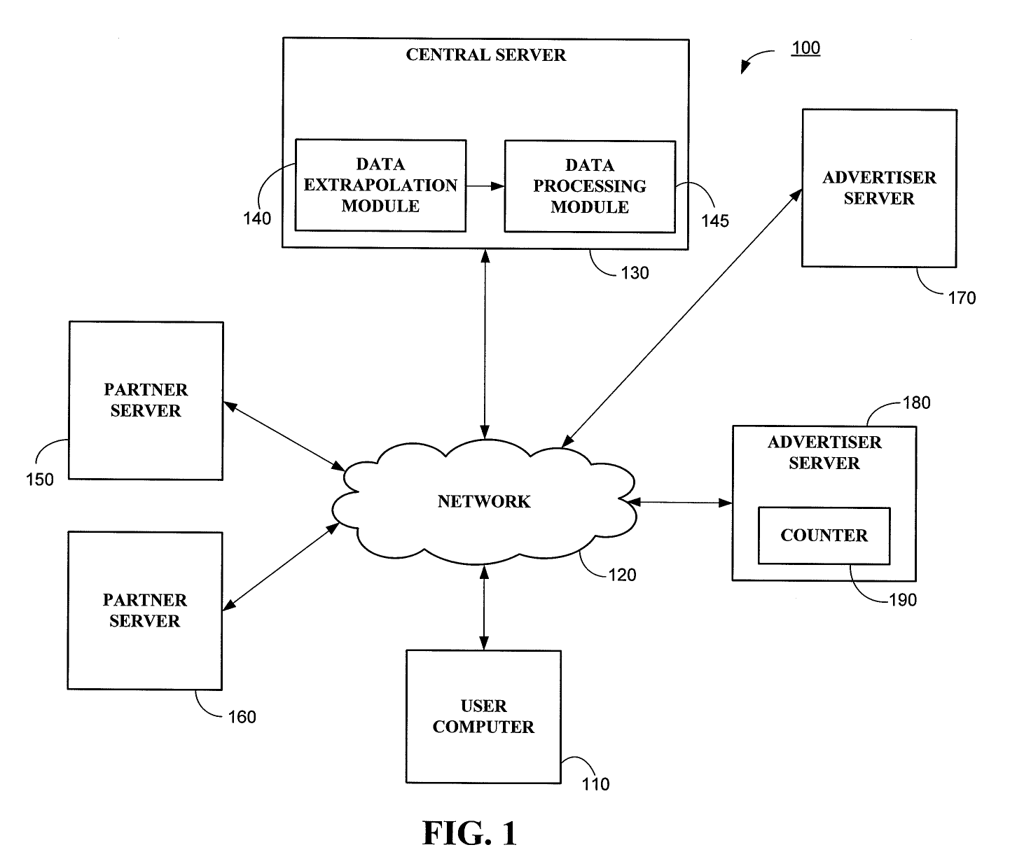

FIG. 1 illustrates one embodiment of a system 100 for assessing advertiser response to changes in click traffic and value that comprises one or more user computers 110, a computer network 120, a central server 130, one or more partner servers 150 and 160, and one or more an advertiser servers 170 and 180. The central server 130 may comprise one or more of a data extrapolation module 140 and a data processing module 145. An advertiser server 170 and 180 may comprise a counter 190.

The computer network 120 may be any type of computerized network capable of transferring data, such as the Internet. According to one embodiment of the invention, the user computer 110, the central server 130, the partner servers 150 and 160, and the advertiser servers 170 and 180 may be programmable processor-based computer devices that include persistent and transient memory, as well as one or more network connection ports for transmitting and receiving data on the network 120. The central server 130 may host websites, store data, serve ads, etc. The user computer 110 may be, for example, a PC, a laptop, a cell phone, a PDA, a smart appliance, etc. that utilizes a network interface (e.g. a web browser, a command line interface) for communicating with various other devices on the network 120. Those of skill in the art understand that any number and type of central server 130, partner servers 150 and 160, and user computer 110 may be connected to the network 120.

According to one embodiment of the invention, the data extrapolation module 140 and the data processing module 145 of the central server 130 may comprise one or more processing elements operative to perform processing operations in response to executable instructions, collectively as a single element or as various processing modules, wherein a given module may be locally or remotely located vis-à-vis another module.

In accordance with one embodiment, the user computer 110, the central server 130, the partner servers 150 and 160, and the advertiser servers 170 and 180 are communicatively interconnected via the communications network 120. The user computer 110 may access one or more websites that a given partner server 150 and 160 may provide over the network 120. The central server 130 provides one or more links to on-line advertisements offered by the advertiser server 170 on the websites offered by the partner server 150 and the second partner server 160 to the user computer 110 via the computer network 120. For example, the central server 130 may serve an advertisement for a product or service to the web site offered by the partner server 150 or the partner server 160. The user computer 110 may then transmit an HTTP request to the partner web site 150 which in turn transmits the webpage with an advertisement for the product or service offered by the advertiser server 170 from the central server 130.

When a user clicks on an advertisement on the page that the web site offered by the partner servers 150 or 160 provides, the user may be redirected to a web site provided by the advertiser server 180 via the communication network 120, e.g., a web page that allows the user to purchase the advertised product or service. When the advertiser server 180 provides the page to the user computer 110, a user utilizing the user computer 110 may take an action that the advertiser server 180 identifies as a conversion. When a user performs an action that the advertiser server 180 identifies as a conversion, a counter 190 at the advertiser server 180 may log (or send a packet up to the central server 130 signaling) a conversion. The conversion may be compiled into counter data (along with other advertising metrics) and transmitted to the central server 130 for analysis.

The data extrapolation module 140 of the central server 130 may log the counter data and corresponding advertising metrics and transmit the data to the data processing module 145 of the central server 130. For example, the data extrapolation module 140 may log a given one of the conversions, as well as corresponding information such as time stamps, IP addresses and corresponding keywords, which may be received from the advertiser server 180. The data processing module 145 receives the conversation data and corresponding advertising metrics and may calculate derivative advertising metrics for one or more conversions. The data processing module 145 may also use advertising metrics and calculated derivative metrics to assess advertiser response by predicting response to keyword markets. For example, the data processing module 145 may calculate the probability of reaction of a keyword market to changes in click value.

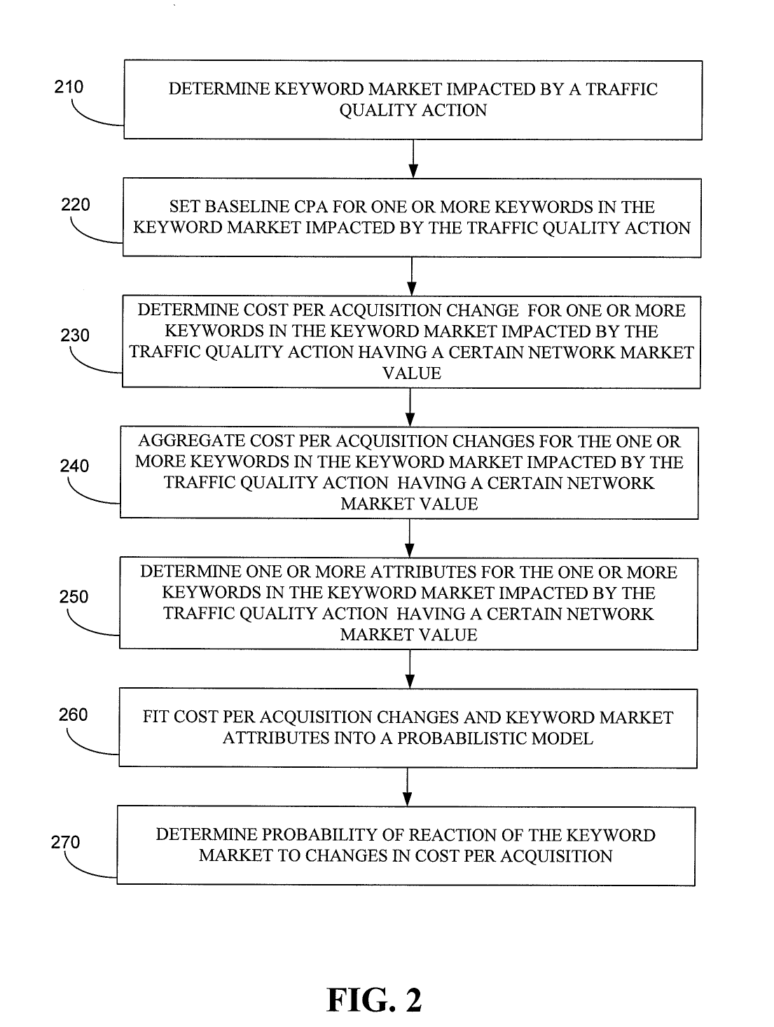

FIG. 2 illustrates a flow diagram presenting a method for assessing advertiser response to change in click traffic and value according to one embodiment of the present invention. In accordance with the embodiment of FIG. 2, the method may begin by determining a keyword market impacted by a traffic quality action, step 210. In one embodiment, a traffic quality action may be the additional or removal of a partner which maintains a partner server that offers one or more websites through a content provider that maintains a central server in a communications network. For example the partner server 150 of the system in FIG. 1 may be removed as the partnership between a content provider operating the central server 130 and the partner operating the partner server 15 has ended. In another embodiment, traffic quality action may be a change in a price paid for the advertisement.

The following example will serve to further illustrate the present embodiment. A given keyword market, “car insurance online quotes”, may correspond to multiple websites offered by different partner severs, e.g. partner server 150 and partner server 160 where one or more advertisers place online advertisements, such as the advertiser which operates the advertiser server 170 of FIG. 1. Partner server 150 may cease to offer its website, thereby removing a website associated with the keyword market “car insurance online quotes.” As a result, the keyword market “car insurance online quotes” is determined to be a keyword market impacted by a traffic quality action.

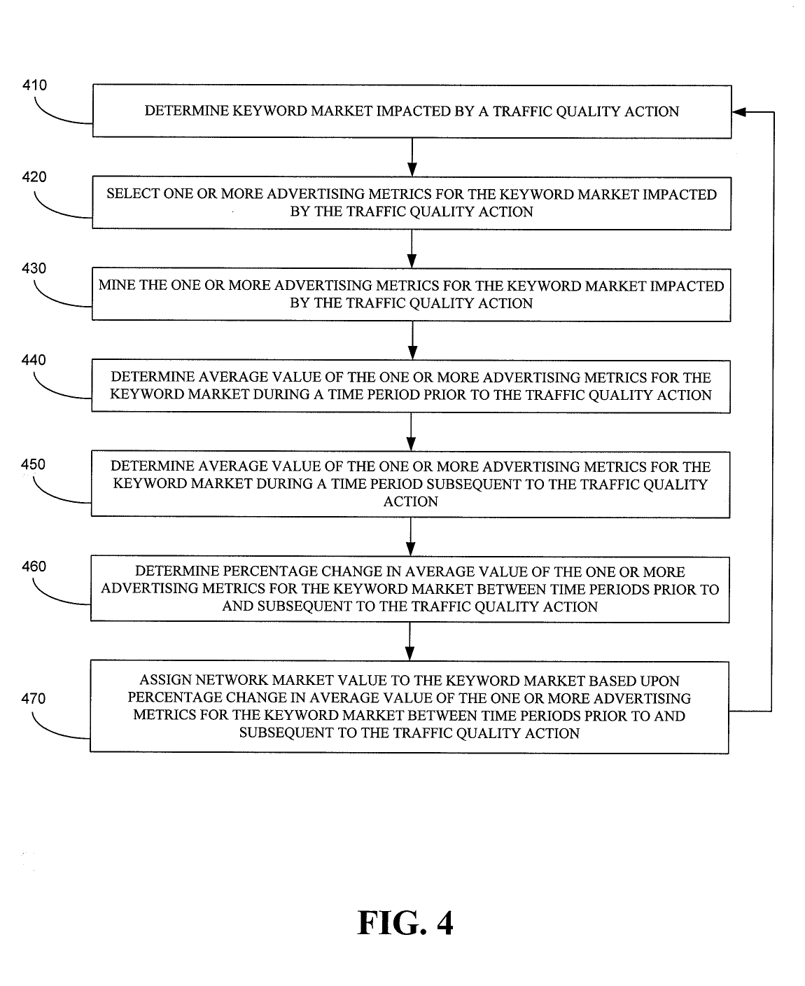

A baseline cost per acquisition may then be set for one or more keywords in the keyword markets impacted by a traffic quality event, step 220. Methods for assigning a network value to one or more keywords in the keyword market impacted by a traffic quality event will be described in further detail below with respect to the description of FIGS. 4 through 7.

A determination may be then made as to the change in cost per acquisition value for one or more keywords in the keyword market impacted by a traffic quality event having a certain network market value, step 230. The change in cost per conversion value for one or more keywords in the keyword market impacted by the traffic quality event is then aggregated, step 240.

One or more attributes may then be determined for the keyword market impacted by a traffic quality event, step 250. The aggregated cost per acquisition changes and selected keyword market attributes may be then fit into a probabilistic model, step 260. For example, the aggregated cost per acquisition changes for the keyword market “car insurance online quotes” as well as values for the keyword market attributes average cost, average cost per bidder, average cost per account, number of accounts which have more than 5000 clicks and total clicks may be used as independent variables in a probabilistic model. According to one embodiment, the probabilistic model may be a logistic regression model which is modeled using a logistic transformation where the output values range from 0 to 1, a value of “0” indicating no probability of reaction and a value of “1” indicating a one hundred percent chance of probability. A determination may then be made of the probability of reaction of the keyword market to changes in costs per acquisition, step 270. For example, the aggregated cost per acquisition changes and the keyword market attributes for the keyword market “car insurance online quotes” may serve as the input into a logistic regression model and the output may be a calculated probability of reaction of a keyword market to a change in click value, i.e. change in cost per acquisition.

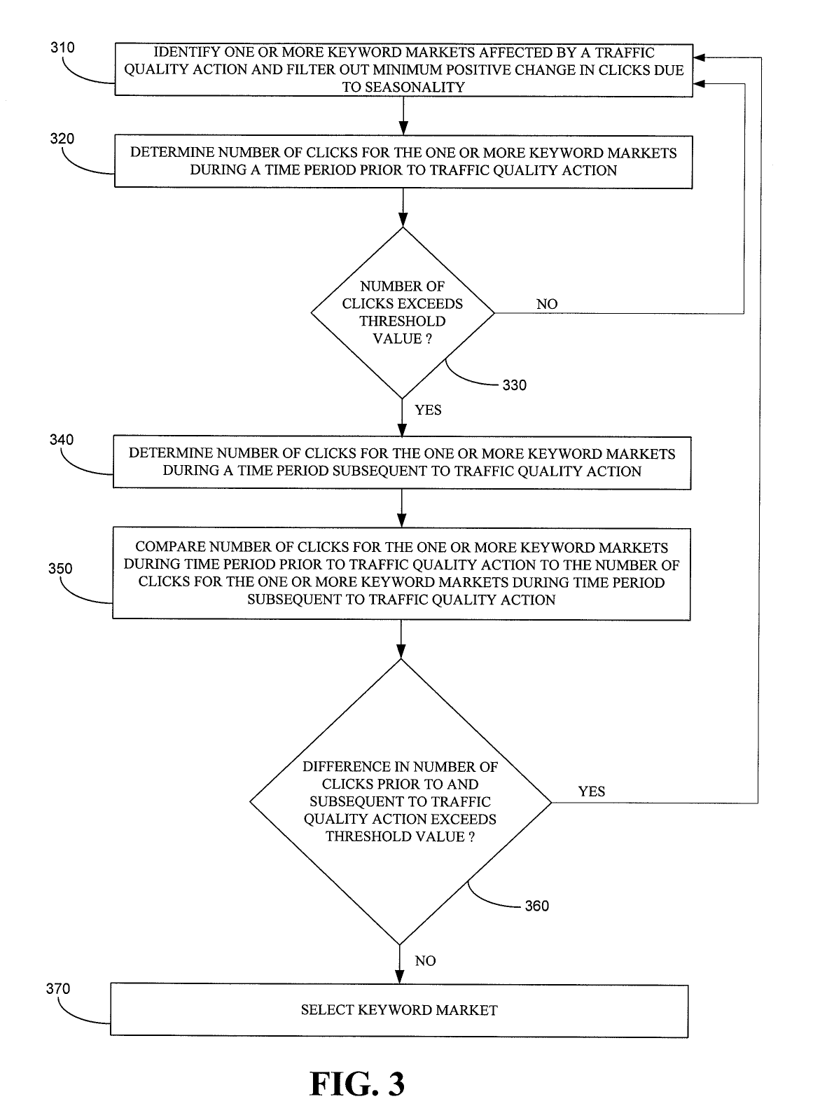

FIG. 3 illustrates a flow diagram presenting a method for selecting a keyword market impacted by a traffic quality action in order to assess advertiser response according to one embodiment of the present invention. In accordance with the embodiment of FIG. 3, the method may begin by identifying one or more keyword markets affected by a traffic quality action, step 310, which may include filtering out minimum positive change in clicks due to seasonality. A determination may then be made as to the number of clicks for the one or more keyword markets during a time period prior to the traffic quality action, step 320. The number of clicks for a given keyword market may be determined by extrapolating previous click data collected for a given time period. For example, a content provider may extrapolate and log click data for keyword markets on a monthly basis and may elect to use an average of the click data for the most recent two month period prior to a traffic quality action to make a determination as to the number of clicks for one or more keyword markets.

In step 330, the number of clicks determined may be compared to a threshold value. For example, it may be determined that only those keyword markets which received an average of at least 1000 clicks in a one month period are to be considered for further analysis. If a given keyword market fails to have received more than an average of 1000 clicks for a one month period, the process may return to step 310 in order to identify further keywords markets affected by a traffic quality action that are to be considered. If a given keyword market has received more than an average of 1000 clicks for a one month period, then a determination may be made as to the number of clicks for the keyword market during a time period subsequent to the traffic quality action, step 330. For example, a content provider may elect to use an average of the click data for the two month period immediately subsequent to the traffic quality action to make a determination as to the number of clicks for one or more keyword markets by looking to the monthly click data that is continuously extrapolated and logged.

A comparison may then be performed as to the number of clicks determined for the one or more keyword markets during a time period prior to the traffic quality action to the number of clicks for the one or more keyword markets during the time period subsequent to the traffic quality action, step 350. For example, for a given keyword market, a determination may have been made that the average number of clicks prior to the traffic quality action was 1100 clicks and the average number of clicks subsequent to the traffic quality action was 1500 clicks. In step 360, a determination may be made as to whether the difference in the number of clicks prior to and subsequent to the traffic quality action exceeds a threshold value. For example, the threshold value may be +/−20%, so that in the previous example, the difference in the number of clicks prior to and subsequent to the traffic quality action would be 26.67%. In such a case, the difference exceeds the thresholds value, and the process will return to step 310 in order to identify further keywords markets affected by a traffic quality action that are to be considered. However, in the event the that the difference did not exceed the threshold value, i.e. the difference in the number of clicks prior to and subsequent to the traffic quality action was less than 20%, the keyword market would be selected for analysis in order to assess advertiser response.

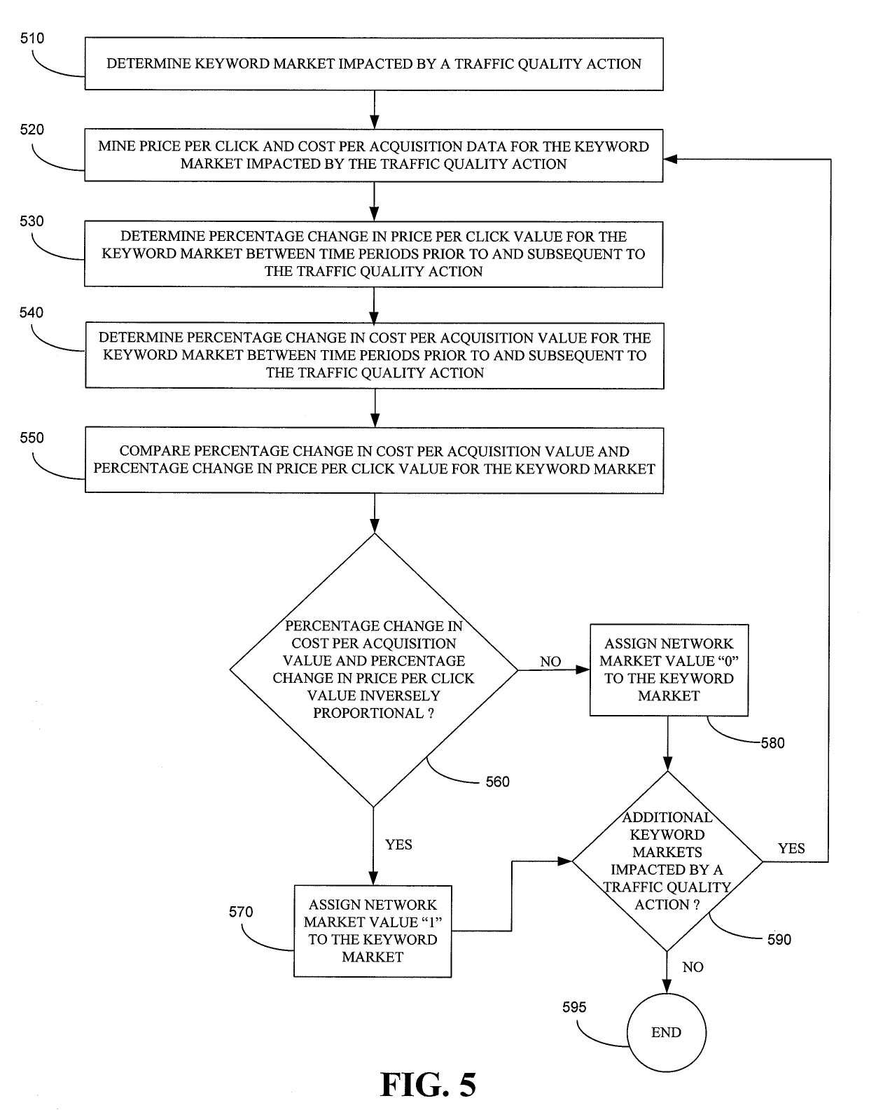

FIG. 4 illustrates a flow diagram presenting a method for assigning a network market value to a keyword market impacted by a traffic quality action in order to assess advertiser response according to one embodiment of the present invention. In accordance with the embodiment of FIG. 4, the method may begin by determining a keyword market impacted by a traffic quality action, step 410. One or more advertising metrics for the keyword market impacted by the traffic quality action may then be selected, step 420. For example, the advertising metrics price-per-click (PPC) and cost per acquisition (CPA) for one or more keyword markets may be selected. The one or more advertising metrics for the keyword market impacted by the traffic quality action may be then mined, step 430. For example, PPC and CPA data for the given keyword market is extrapolated from one or more sets of data collected by a content provider from a given time period. The average values of the one or more advertising metrics for the keyword market during a time period prior to the traffic quality action, step 440, and subsequent to the traffic quality action, step 450, may be then determined. A percentage change in the average values of the one or more advertising metrics for the keyword market between time periods prior to and subsequent to the traffic quality action may be then determined, step 460. Based upon the percentage change in the average values of the one or more advertising metrics for the keyword market between time periods prior to and subsequent to the traffic quality action, a change in PPC may be assigned to the keyword market, step 470. Exemplary embodiments of the method illustrated in FIG. 4 will be described in further detail below with respect to the description of FIGS. 5 through 7.

FIG. 5 illustrates a flow diagram presenting a method for assigning a network market value to a keyword market impacted by a traffic quality action in order to assess advertiser response according to another embodiment of the present invention. In accordance with the embodiment of FIG. 5, the method may begin by determining a keyword market impacted by a traffic quality action, step 510. Data for the advertising metrics PPC and CPA for the keyword market impacted by the traffic quality action may be then mined, step 520. The PPC and CPA data for a given keyword market may be mined by extrapolating previous PPC and CPA collected for a given time period.

A determination of the percentage change in the PPC value for the keyword market between time periods prior to and subsequent to the traffic quality action may be then made, step 530. A determination of the percentage change in the CPA value for the keyword market between time periods prior to and subsequent to the traffic quality action may also be made, step 540. For example, a content provider may extrapolate and log PPC and CPA data for keyword markets on a monthly basis and may calculate a percentage change of the average PPC and CPA data for the most recent two month period prior to a traffic quality action and for a two month period subsequent to the traffic quality action.

A comparison of the percentage change in the CPA value and the percentage change in the PPC value for the keyword market may then be performed, step 550. A determination may be then made as to whether the percentage change in CPA value is inversely proportional to the percentage change in PPC value for the keyword market, step 560. If the relationship between the percentage change in PPC value and the percentage change in CPA value is inversely proportional, a network market value “1” may be assigned to the keyword market, step 570. For example, where an increase in the percentage change of the PPC value follows a decrease in the percentage change of the CPA value, the keyword market will be categorized with the network market value “1” indicating that the market is rational with respect to the price to value relationship. Where the relationship is not inversely proportional, a network market value “0” may be assigned to the keyword market, step 580. In step 590, a determination may be then made as to whether there exist additional keyword markets impacted by a traffic quality action. Where additional keyword markets impacted by a traffic quality action do exist, the process may then return to step 520; where no additional keyword markets impacted by a traffic quality are available, the method will end, step 595.

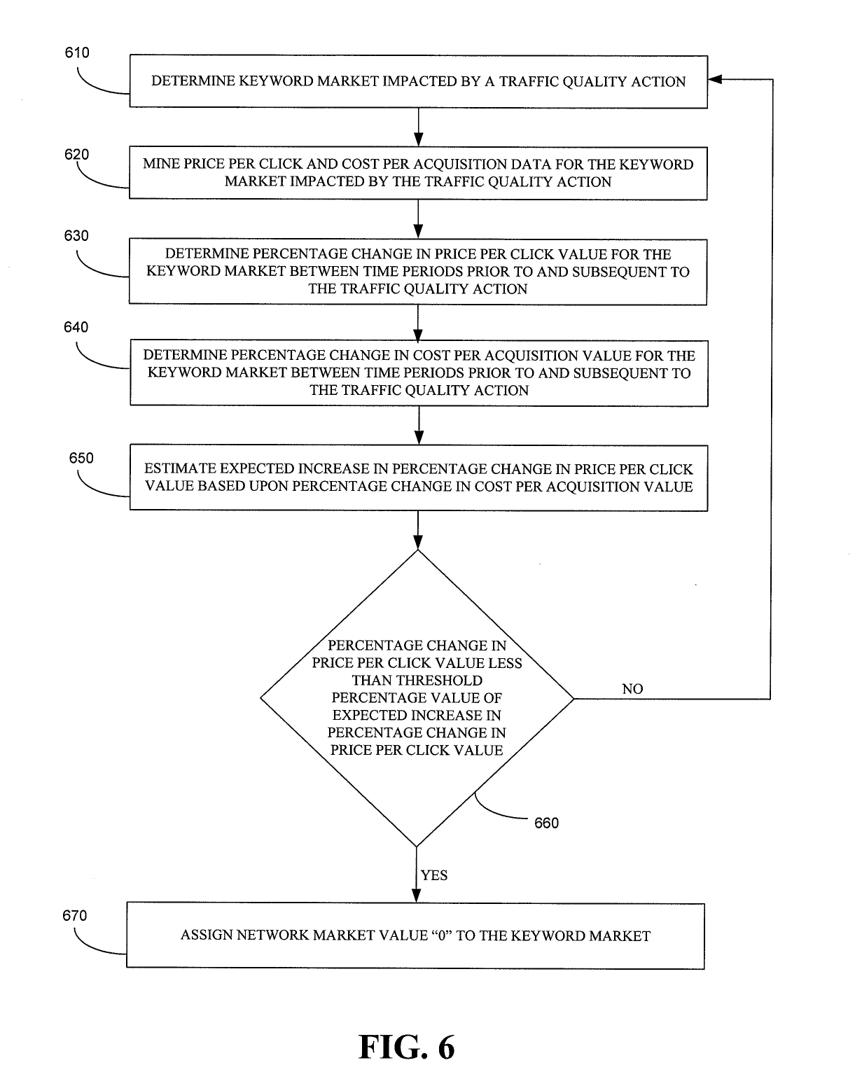

FIG. 6 illustrates a flow diagram presenting a method for assigning a network market value to a keyword market impacted by a traffic quality action in order to assess advertiser response according to another embodiment of the present invention. In accordance with the embodiment of FIG. 6, the method may begin by determining a keyword market impacted by a traffic quality action, step 610. Data for the advertising metrics PPC and CPA for the keyword market impacted by the traffic quality action may be then mined, step 620. The PPC and CPA data for a given keyword market may be mined by extrapolating previous PPC and CPA collected for a given time period. A percentage change in PPC value for the keyword market between time periods prior to and subsequent to the traffic quality action may then be determined, step 630. A percentage change in the CPA value for the keyword market between time periods prior to and subsequent to the traffic quality action may also be determined, step 640. As described in a previous example, a content provider may extrapolate and log PPC and CPA data for keyword markets on a monthly basis and may calculate a percentage change of the average PPC and CPA data for the most recent two month period prior to a traffic quality action and for a two month period subsequent to the traffic quality action. The expected increase in percentage change in PPC value based upon the percentage change in CPA value may then be estimated, step 650.

In step 660, the percentage change in PPC value is compared to the threshold percentage value of the expected increase in percentage per click value. For example, the threshold percentage value may be 20% of the expected increase in percentage change in PPC value based upon the percentage change in CPA value. Where the percentage change in PPC value is less than the threshold value of 20%, a network market value “0” may be assigned to the keyword market, step 670. The percentage change in PPC value may exceed the threshold percentage value of the expected increase in percentage change in PPC value, which may result in the process returning to step 610.

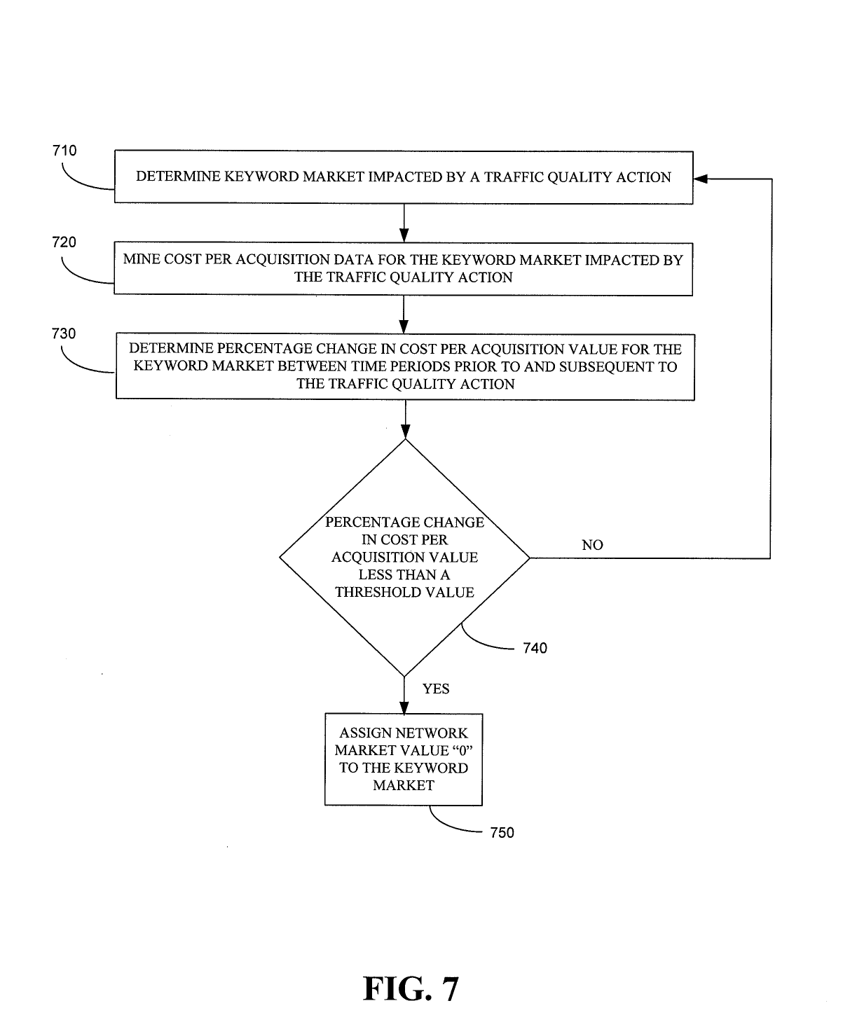

FIG. 7 illustrates a flow diagram presenting a method for assigning a network market value to a keyword market impacted by a traffic quality action in order to assess advertiser response according to another embodiment of the present invention. In accordance with the embodiment of FIG. 7, the method may begin by determining a keyword market impacted by a traffic quality action, step 710. Data for the advertising metric CPA for the keyword market impacted by the traffic quality action may be then mined, step 720. As described in previous example, the CPA data for a given keyword market may be mined by extrapolating previous CPA date collected for a given time period. A percentage change in CPA value for the keyword market between time periods prior to and subsequent to the traffic quality action may then be determined, step 730. In step 740, a determination may be made as to whether the percentage change in CPA value is less than a threshold value

In accordance with the foregoing description, the present invention provides systems, methods and computer program products to assess advertiser response that addresses the limitations of current advertiser response assessment techniques and has the ability to easily integrate with existing systems.

FIGS. 1 through 7 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for assessing advertiser response, the method comprising:
determining one or more keyword markets impacted by a traffic quality action;
setting a baseline cost per acquisition for the one or more keyword markets impacted by the traffic quality action;
determining one or more advertising metrics for the one or more keyword markets impacted by the traffic quality action having a certain network market value;
fitting the one or more advertising metrics into a probabilistic model; and
determining the probability of reaction of the one or more keyword markets to changes in the one or more advertising metrics on the basis of the probabilistic model.

2. The method of claim 1 wherein determining the one or more advertising metrics comprises determining a cost per acquisition.

3. The method of claim 1 wherein determining one or more keyword markets impacted by a traffic quality action comprises:
identifying one or more keyword markets affected by a traffic quality action;
determining a number of clicks for the one or more keyword markets during a time period prior to the traffic quality action;
determining a number of clicks for the one or more keyword markets during a time period subsequent to the traffic quality action;
comparing the number of clicks of the one or more keyword markets during a time period prior to the traffic quality action to the number of clicks of the one or more keyword markets during a time period subsequent to the traffic quality action; and
selecting one or more keyword markets on the basis of the comparison.

4. The method of claim 1 wherein setting a baseline cost per acquisition for the one or more keyword markets impacted by the traffic quality action comprises:
determining a keyword market impacted by the traffic quality action;
selecting one or more advertising metrics for the keyword market impacted by the traffic quality action;
mining the one or more advertising metrics for the keyword market impacted by the traffic quality action;
determining the average value of the one or more advertising metrics for the keyword market during a time period prior to the traffic quality action;
determining the average value of the one or more advertising metrics for the keyword market during a time period subsequent to the traffic quality action;
determining percentage change in average value of the one or more advertising metrics for the keyword market between time periods prior to the traffic quality action and subsequent to the traffic quality action; and
assigning a network market value to the keyword market on the basis of a percentage change in average value of the one or more advertising metrics for the keyword market between time periods prior to the traffic quality action and subsequent to the traffic quality action.

5. The method of claim 4 wherein determining the one or more advertising metrics comprises determining an advertising metric selected from the set of advertising metrics that include a price per click and a cost per acquisition.

6. Computer readable media comprising program code that when executed by a programmable causes execution of a method for assessing advertiser response, the computer readable media comprising:
program code for determining one or more keyword markets impacted by a traffic quality action;
program code for setting a baseline cost per acquisition for the one or more keyword markets impacted by the traffic quality action;
program code for determining one or more advertising metrics for the one or more keyword markets impacted by the traffic quality action having a certain network market value;
program code for fitting the one or more advertising metrics into a probabilistic model; and
program code for determining the probability of reaction of the one or more keyword markets to changes in the one or more advertising metrics on the basis of the probabilistic model.

7. The computer readable media of claim 6 wherein program code for determining the one or more advertising metrics comprises program code for determining a cost per acquisition.

8. The computer readable media of claim 6 wherein program code for determining one or more keyword markets impacted by a traffic quality action comprises:
program code for identifying one or more keyword markets affected by a traffic quality;
program code for determining the number of clicks for the one or more keyword markets during a time period prior to a traffic quality action;
program code for determining a number of clicks for the one or more keyword markets during a time period subsequent to the traffic quality action;
program code for comparing the number of clicks of the one or more keyword markets during a time period prior to the traffic quality action to the number of clicks of the one or more keyword markets during a time period subsequent to the traffic quality action; and
program code for selecting one or more keyword markets on the basis of the comparison.

9. The computer readable media of claim 6 wherein program code for setting a baseline cost per acquisition for the one or more keyword markets impacted by the traffic quality action comprises:
program code for determining a keyword market impacted by a traffic quality action;
program code for selecting one or more advertising metrics for the keyword market impacted by the traffic quality action;
program code for mining the one or more advertising metrics for the keyword market impacted by the traffic quality action;
program code for determining the average value of the one or more advertising metrics for the keyword market during a time period prior to the traffic quality action;
program code for determining the average value of the one or more advertising metrics for the keyword market during a time period subsequent to the traffic quality action;
program code for determining percentage change in average value of the one or more advertising metrics for the keyword market between time periods prior to and subsequent to the traffic quality action; and
program code for assigning a network market value to the keyword market based upon percentage change in average value of the one or more advertising metrics for the keyword market between time periods prior to the traffic quality action and subsequent to the traffic quality action.

10. The computer readable media of claim 9 wherein program code for determining the one or more advertising metrics comprises program code determining an advertising metric selected from the set of advertising metrics that include a price per click and a cost per acquisition.

11. A system for assessing advertiser response, the system comprising:
a data extrapolation module operative to extrapolate data corresponding to one or more keyword markets; and
a data processing module operative to:
determine one or more keyword markets impacted by a traffic quality action,
setting a baseline cost per acquisition for the one or more keyword markets impacted by the traffic quality action,
determine one or more advertising metrics for the one or more keyword markets impacted by the traffic quality action having a certain network market value,
fit the one or more advertising metrics into a probabilistic model; and
determine the probability of reaction of the one or more keyword markets to changes in the one or more advertising metrics on the basis of the probabilistic model.

12. The system of claim 11 wherein the data processing module is operative to determine an advertising metric comprising a cost per acquisition.

13. The system of claim 11 wherein the data processing module is operative to:
identify one or more keyword markets affected by a traffic quality;
determine the number of clicks for the one or more keyword markets during a time period prior to a traffic quality action;
determine a number of clicks for the one or more keyword markets during a time period subsequent to the traffic quality action;
compare the number of clicks of the one or more keyword markets during a time period prior to the traffic quality action to the number of clicks of the one or more keyword markets during a time period subsequent to the traffic quality action; and
select one or more keyword markets on the basis of the comparison.

14. The system of claim 11 wherein the data processing module is operative to:
determine a keyword market impacted by a traffic quality action;
select one or more advertising metrics for the keyword market impacted by the traffic quality action;
mine the one or more advertising metrics for the keyword market impacted by the traffic quality action;
determine the average value of the one or more advertising metrics for the keyword market during a time period prior to the traffic quality action;
determine the average value of the one or more advertising metrics for the keyword market during a time period subsequent to the traffic quality action;
determine percentage change in average value of the one or more advertising metrics for the keyword market between time period prior to the traffic quality action and subsequent to the traffic quality action; and
assign a network market value to the keyword market on the basis of a percentage change in average value of the one or more advertising metrics for the keyword market between time periods prior to the traffic quality action and subsequent to the traffic quality action.

15. The system of claim 14 wherein the data processing module is operative to determine an advertising metric selected from the set of advertising metrics that include a price per click and a cost per acquisition.
